(19) United States
(12) Patent Application Publication
(10) Pub. No.: US 2004/0176945 A1
(43) Pub. Date: Sep. 9, 2004

(54) Apparatus and method for generating finite state transducer for use in incremental parsing

(75) Inventors: Yasuyoshi Inagaki, Nagoya-shi (JP); Shigeki Matsubara, Nagoya-shi (JP); Yoshihide Kato, Toki-shi (JP); Keiichi Minato, Kobe-shi (JP)

Correspondence Address: OLIFF & BERRIDGE, PLC, P.O. BOX 19928, ALEXANDRIA, VA, 22320, US

(73) Assignee: Nagoya Industrial Science Research Institute, Nagoya-shi (JP)

(21) Appl. No.: 10/661,497

(22) Filed: Sep. 15, 2003

(30) Foreign Application Priority Data
Mar. 6, 2003 (JP) 2003-060681

(51) Int. Cl. G06F 17/28

(52) U.S. Cl. 704/4

(57) ABSTRACT

A finite state transducer generator includes a recursive transition network creating part that creates a recursive transition network, an arc replacement part that recursively repeats an operation where an arc in a finite state transducer is replaced by a network corresponding to an input label of the arc by a network in the recursive transition network, and a priority calculating part that calculates an arc replacement priority based on statistical information regarding frequency of applying grammar rules. The arc replacement part replaces arcs in descending order of arc replacement priority. Therefore, the finite state transducer generator can generate a finite state transducer capable of parsing a considerable great number of sentences within a limited size.

### FIELD OF THE INVENTION

The invention relates to an apparatus and a method for generating a finite state transducer for use in incremental parsing in real-time spoken language processing systems, a computer-readable recording medium storing a finite state transducer generating program, and an incremental parsing apparatus.

### DESCRIPTION OF THE RELATED ART

Real-time spoken language processing systems such as a simultaneous interpretation system needs to recognize speech and make a response to the speech simultaneously. To achieve these processes, implementing parsing in order every time a fragment of speech is inputted, rather than implementing parsing after a whole sentence is inputted, is essential. This is referred to as incremental parsing.

As a framework for understanding sentence structures incrementally, several incremental parsing methods have been proposed so far. In incremental parsing, parse trees are generated from fragments of what have been inputted, even in the middle of speech. Thus, it is possible to understand a parse structure as of time of parsing at a stage where the input of the whole sentence is not completed. As the incremental parsing methods, Matsubara, et al., have proposed an incremental chart parsing algorithm in S. Matsubara, et al. “Chart-based Parsing and Transfer in Incremental Spoken Language Translation”, Proceedings of NLPRS'97, pp.521-524 (1997). In this algorithm, context-free grammar rules are continuously applied to each input word, parse trees corresponding to each input word are generated, and connected with matching parse trees corresponding to each fragment of a sentence. However, the incremental chart-parsing algorithm has a problem that it is difficult to obtain sufficient performance on the real time performance required in the real-time spoken language processing systems.

To overcome the above problem in the incremental chart parsing algorithm, the inventors of the present invention have proposed an incremental parsing algorithm which uses finite state transducer in Minato et al., “Incremental Parsing using Finite State Transducer”, Record of 2001 Tokai-Section Joint Conference of the Eighth Institute of Electrical and Related Engineers, Japan, P.279 (2001). This parsing algorithm can realize high speed parsing, since it executes parsing using a finite state transducer generated by approximate transformation of context-free grammars.

However, with the above parsing, as a result of approximate transformation, there is a problem that a sentence, which could be parsed with the original context-free grammar, cannot be parsed with the finite state transducer. The finite state transducer for use in the incremental parsing is generated by recursively replacing arcs in each network that represents grammar rules. However, owing to the limitation of memory size of a computer used to generate and/or to implement the finite state transducer, there are some cases where all arcs required for parsing cannot be replaced. As a result, the problem that a sentence, which could be parsed with the original context-free grammar, cannot be parsed with the finite state transducer occurs.

### SUMMARY OF THE INVENTION

The present invention provides an apparatus and a method for generating a finite state transducer for use in incremental parsing capable of incrementally parsing a great number of sentences, a computer-readable recording medium storing a finite state transducer generating program, and an apparatus for incremental parsing.

According to one aspect of the invention, an apparatus for generating a finite state transducer for use in incremental parsing may include a recursive transition network creating device that creates a recursive transition network, the recursive transition network being a set of networks, each network representing a set of grammar rules based on a context-free grammar by states and arcs connecting the states, each arc having an input label and an output label, each network having a recursive structure where each transition labeled with a non-terminal symbol included in each of the networks is defined by another network; an arc replacement device that replaces an arc having an input label representing a start symbol included in the finite state transducer in an initial state by a network corresponding to the input label of the arc in the recursive transition network and further recursively repeats an arc replacement operation for replacing each arc, which is newly created from a replaced network, by another network in the recursive transition network; and a priority calculating device that calculates a derivation probability to derive a node of a parse tree corresponding to each of arcs whose input labels are non-terminal symbols in the finite state transducer based on statistical information regarding frequency of applying grammar rules and determines an arc replacement priority in terms of an obtained derivation probability. The arc replacement device continues applying the arc replacement operation to each arc included in the finite state transducer in descending order of the arc replacement priority until the finite state transducer reaches a predetermined size.

In the apparatus, the arc replacement operation is applied to the arcs in descending order of the arc replacement priority obtained based on the statistical information regarding the frequency of applying the grammar rules, thus reliably generating a finite state transducer capable of parsing a great number of sentences within the limited size.

The apparatus further includes an arc eliminating device that, after the application of the arc replacement operation by the arc replacement device terminates, eliminates arcs whose input labels are non-terminal symbols and further performs the arc replacement operation.

Therefore, in the apparatus, the arcs whose input labels are non-terminal symbols, which are not used for parsing, are eliminated and the arc replacement operation is concurrently performed, thus generating a finite state transducer capable of parsing a further great number of sentences.

In the apparatus, the derivation probability for a certain node represents a probability that grammar rules are applied in order to each node on a path from a root node to the certain node in the parse tree. The derivation probability P (Xr_{M(lm)}) for node Xr_{M(lm)} may be determined as follows:

$$P ( {X}_{{r}_{M ( {l}_{M} )}} ) = {\prod }_{i = 1}^{M} \hat{P} ( {r}_{i} \vert {r}_{i - N + 1 ( {l}_{i - N + 1} )} , … , {r}_{i - 1 ( {l}_{i - 1} )} )$$

wherein rᵢ represents a grammar rule, rᵢ(lᵢ) represents that grammar rule rᵢ is applied and grammar rule rᵢ+1 to be applied next is applied to a node generated by the (lᵢ)-th element of the right side of rᵢ, and N is a predetermined positive integer.

The arc replacement operation is performed using the probability as an arc replacement order, thus reliably generating a finite state transducer capable of parsing a further great number of sentences.

According to another aspect of the invention, a computer-readable recording medium stores a program for generating a finite state transducer for use in incremental parsing. The program includes a recursive transition network creating routine that creates a recursive transition network, the recursive transition network being a set of networks, each network representing a set of grammar rules based on a context-free grammar by states and arcs connecting the states, each arc having an input label and an output label, each network having a recursive structure where each transition labeled with a non-terminal symbol included in each of the networks is defined by another network; an arc replacement routine that replaces an arc having an input label representing a start symbol included in the finite state transducer in an initial state by a network corresponding to the input label of the arc in the recursive transition network and further recursively repeats an arc replacement operation for replacing each arc, which is newly created from a replaced network, by another network in the recursive transition network; and a priority calculating routine that calculates a derivation probability to derive a node of a parse tree corresponding to each of arcs whose input labels are non-terminal symbols in the finite state transducer based on statistical information regarding frequency of applying grammar rules and determines an arc replacement priority in terms of an obtained derivation probability. In the program, the arc replacement routine continues applying the arc replacement operation to each arc included in the finite state transducer in descending order of the arc replacement priority until the finite state transducer reaches a predetermined size.

By causing the computer to execute the program, the arc replacement operation is applied to the arcs in descending order of the arc replacement priority obtained based on the statistical information regarding the frequency of applying the grammar rules, thus reliably generating a finite state transducer capable of parsing a great number of sentences within the limited size.

According to a further aspect of the invention, a method for generating a finite state transducer for use in incremental parsing may includes the steps of creating a recursive transition network, the recursive transition network being a set of networks, each network representing a set of grammar rules based on a context-free grammar by states and arcs connecting the states, each arc having an input label and an output label, each network having a recursive structure where each transition labeled with a non-terminal symbol included in each of the networks is defined by another network; replacing an arc having an input label representing a start symbol included in the finite state transducer in an initial state by a network corresponding to the input label of the arc in the recursive transition network and further recursively repeating an arc replacement operation for replacing each arc, which is newly created from a replaced network, by another network in the recursive transition network; and calculating a derivation probability to derive a node of a parse tree corresponding to each of arcs whose input labels are non-terminal symbols in the finite state transducer based on statistical information regarding frequency of applying grammar rules and determines an arc replacement priority in terms of an obtained derivation probability. In the step of replacing an arc, the arc replacement operation is continued applying to each arc included in the finite state transducer in descending order of the arc replacement priority until the finite state transducer reaches a predetermined size.

With the method, the arc replacement operation is applied to the arcs in descending order of the arc replacement priority obtained based on the statistical information regarding the frequency of applying the grammar rules, thus reliably generating a finite state transducer capable of parsing a great number of sentences within the limited size.

According to another aspect of the invention, an incremental parsing apparatus that perform incremental parsing may include a finite state transducer generated by the method, that is, by applying the arc replacement operation to the arcs in descending order of the arc replacement priority obtained based on the statistical information regarding the frequency of applying the grammar rules, the finite state transducer outputting at least one piece of a parse tree as a result of a state transition when each word is inputted thereto; and a connecting device that sequentially connects each piece of the parse tree outputted by the finite state transducer.

Using the finite state transducer of a limited size approximately transformed from the context-free grammar, the incremental parsing apparatus can parse a great number of sentences.

### BRIEF DESCRIPTION OF THE DRAWINGS

An embodiment of the invention will be described in detail with reference to the following figures wherein:

FIG. 1 is a block diagram showing an entire configuration of a finite state transducer generator according to an embodiment of the invention;

FIG. 2 shows an example of P_{X} representing a set of grammar rules;

FIG. 3 shows an example of M_{X} in a recursive transition network;

FIG. 4 shows that states in the recursive transition network are integrated;

FIG. 5 illustrates an initial finite state transducer M0, which is given first;

FIG. 6 shows an example of an arc replacement operation and an arc-to-node relationship;

FIG. 7 illustrates a process of applying grammar rules to derive a certain node;

FIG. 8 illustrates a set of grammar rules obtained from a parse tree;

FIG. 9 shows four examples explaining how arcs are continuously eliminated;

FIG. 10 is a block diagram showing an entire configuration of an incremental parsing apparatus according to an embodiment of the invention;

FIG. 11 shows an example of a parsing process for a Japanese sentence;

FIG. 12 shows examples of a parse tree represented by output symbols strings; and

FIG. 13 shows an example of a parsing process for an English sentence;

FIG. 14 shows examples of a parse tree represented by output symbols strings; and

FIG. 15 is a graph showing an experimental result (accuracy rate) of a parsing process.

### DETAILED DESCRIPTION OF PREFERRED EMBODIMENTS

An embodiment of the invention will be described in detail with reference to the accompanying drawings.

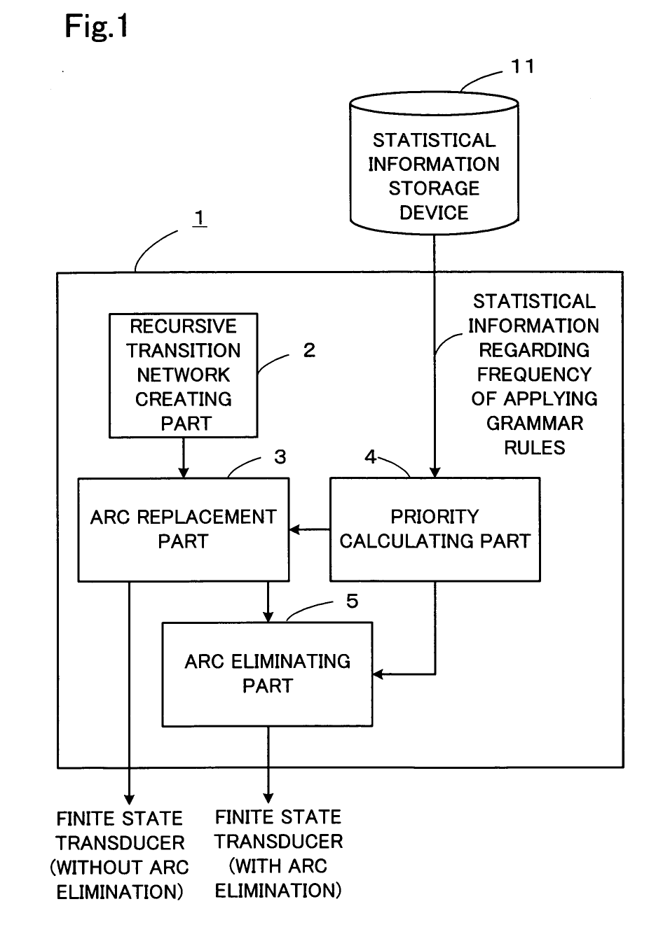

The entire configuration of a finite state transducer generator 1 will be described in detail with reference to FIG. 1. The finite state transducer generator 1 is made up of a recursive transition network creating part 2, an arc replacement part 3, a priority calculating part 4, and an arc eliminating part 5. The finite state transducer generator 1 is connected to a statistical information storage device 11. If an arc replacement operation (described later) is not performed, the arc eliminating part 5 may be eliminated from the configuration of the finite state transducer generator 1.

The finite state transducer generator 1 is realized by a computer, which includes, for example, a central processing unit (CPU), read-only memory (ROM), random-access memory (RAM), a hard disk drive, and a CD-ROM unit. The finite state transducer generator 1 is structured wherein, for example, finite state transducer generating program designed to cause the computer to function as the recursive transition network generating part 2, the arc replacement part 3, the priority calculating part 4 and the arc eliminating part 5 are stored in the hard disk drive, and the CPU reads the finite state transducer program from the hard disk drive and executes the program. If statistical information as to frequency of applying grammar rules stored in a recording medium such as a CD-ROM is read by the computer in advance and stored in the hard disk drive, the hard disk drive functions as the statistical information memory storage 11. As the statistical information regarding the frequency of applying the grammar rules, advanced telecommunications research (ATR) speech database with parse trees (Japanese dialogue) can be used.

Next, contents of processes executed in each of the above parts making up of the finite state transducer generator 1 will be described with reference to the drawings.

Previous to the contents of processes performed in the finite state transducer generator 1, a finite automaton, a finite state transducer, and a context-free grammar will be defined. First, a finite automaton will be defined. A finite automaton is defined in the form of a 5-tuple (Σ, Q, q₀, F, E), where Σ is an alphabet finite set, Q is a finite set of states, q₀∈Q is an initial state, F⊂Q is the set of final states, and E is a finite set of arcs. In addition, E may be defined by: E⊂Q×Σ×Q.

Each finite automaton has one initial state and one or more final states and is a network where state transitions are made according to arc labels. When an arc is defined by (p, A, q)∈ E(p, q∈Q, A∈Σ), state p is referred to as a start point of the arc and state q is referred to as an end point of the arc.

Next, a finite state transducer will be defined. A finite state transducer is defined in the form of a 6-tuple (Σ_{I}, Σ_{O}, Q, q₀, F, E), wherein Σ_{I} and Σ_{O} are a finite set of input alphabets and a finite set of output alphabets respectively, Q is a finite set of states, q₀∈Q is an initial state, F⊂Q is the set of final states, and E is a finite set of arcs. In addition, E may be defined by: E⊂Q×Σ_{I}×Σ_{O}×E

In a finite automaton, an input label is assigned to each arc. In a finite state transducer, an input label and an output label are assigned to each arc. In other words, each arc has an input label and an output label. In a finite state transducer, when an element of Σ_{I} is inputted, an element of Σ_{O} is outputted and a state transition is made. A system using a finite state transducer can both accept inputted symbol strings and output symbol strings corresponding to the inputted ones.

Finally, a context-free grammar will be defined. A context-free grammar is defined in the form of a 4-tuple (N, T, P, S₀), wherein N and T are a non-terminal symbol and a terminal symbol respectively, S⁰∈N is a start symbol and a root node of a parse tree generated from the grammar, P is a set of grammar rules. Each rule is indicated by A→α (A∈N, α= (N∪T)⁺), which indicates A is replaced by a. Most natural language structures can be described by context-free grammars.

Processes of each part making up the finite state transducer generator 1 will be described. In the embodiment, a context-free grammar is represented by a recursive transition network. Each arc in the obtained recursive transition is replaced by another network, thereby obtaining the finite state transducer. The following are descriptions of processes performed in each part. First, a process of creating a recursive transition network in the recursive network creating part 2 will be described, followed by processes of generating the finite state transducer using a replacement operation in the recursive transition network performed in the arc replacement part 3, the priority calculating part 4, and the arc eliminating part 5.

(Process of Creating a Recursive Transition Network in the Recursive Network Generating Part 2)

A recursive transition network is a set of networks that allow transitions labeled with non-terminal symbols. The recursive transition network has a recursive structure where a transition labeled with a non-terminal symbol included in each of the networks is defined by another network. The recursive transition network and the context-free grammar have an equivalent analysis capability. The following is a description of a method to create a recursive transition network, which is equivalent to a context-free grammar, from the context-free grammar. In the created recursive transition network, each network represents a set of grammar rules based on a context-free grammar by states and arcs connecting the states.

When each grammar rule has category X in the left hand side, a network M_{X} representing a set of grammar rules P_{X}, is defined in the form of a 5-tuple (Σ, Q_{X}, i_{X}, F_{X}, E_{X}), wherein Σ=T∪N, i_{X} is an initial state, F_{X} is a set of final states, F_{X}={f_{X}}, Q_{X} is a finite set of states, and E_{X} is a finite set of arcs.

To represent an element of Q_{X}, a grammar rule with a dot symbol (·) is introduced. In the grammar rule with a dot symbol, a dot symbol is inserted into an arbitrary place of the right hand side of a grammar rule such as X→α·β. For notation simplification, the grammar with a dot symbol is represented with a 3-tuple, the left hand side in the grammar rule, the left side of the dot symbol of the right hand side in the grammar rule, and the right side of the dot symbol of the right hand side in the grammar rule. For example, X→α·β is represented as (X, α, β). With the use of this representation, Q_{X}, which is a finite set of states, is defined by:

$${Q}_{X} = \{ ( X , α , β ) \vert X -> α β ∈ {P}_{X} , α , β ∈ {( N ⋃ T )}^{+} \} ⋃ \{ {i}_{X} , {f}_{X} \}$$

Ex, which is a finite set of arcs, is defined by:

$$\begin{matrix}{E}_{X} = \{ ( ( X , α , A β ) , A , ( X , α A , β ) ) \\ \vert X -> α A β ∈ {P}_{X} \} ⋃ \\ \{ ( {i}_{X} , A , ( X , A , β ) ) \vert X -> A β ∈ {P}_{X} ⋃ \\ \{ ( ( X , α , A ) , A , {f}_{X} ) \vert X -> α A ∈ {P}_{X} ⋃ \\ \{ ( {i}_{X} , A , {f}_{X} ) \vert X -> A ∈ {P}_{X} \}\end{matrix}$$

wherein X∈N, A∈N∪T, α, β∈ (N∪T)⁺.

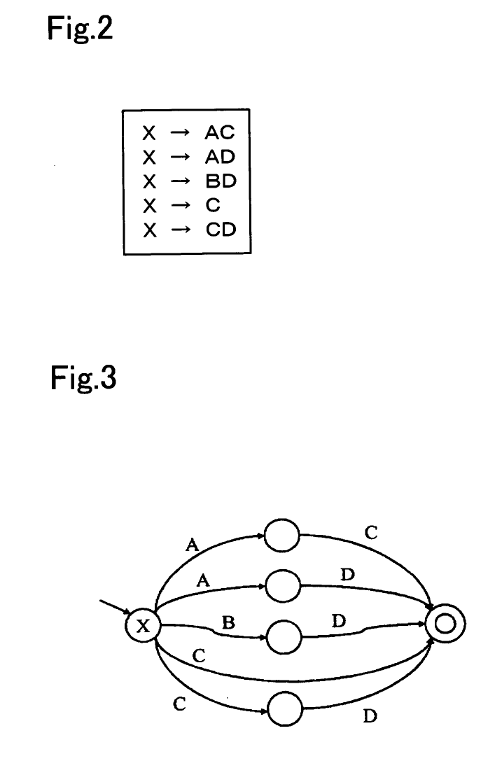

For example, when P_{X} is a set of grammar rules shown in FIG. 2, M_{X} is a network shown in FIG. 3. A path from the initial state i_{X} to the final state f_{X} of the network M_{X} corresponds to a grammar rule in P_{X}. Therefore, when a symbol string on the right hand side of a grammar rule is inputted to a network M_{X}, a state transition from i_{X} to f_{X} is made along a path in M_{X} corresponding to the grammar rule. In the embodiment, a recursive transition network M is defined as a set of networks M_{X} by:

$$ℳ = \{ {M}_{X} \vert X ∈ N \}$$

(Process of Simplifying the Recursive Transition Network in the Recursive Transition Network Creating Part 2)

A recursive transition network created above may include some arcs having equivalent start points and the same labels, which produce redundancy, and state transitions cannot be decisively made. Therefore, states are integrated based on a finite automaton minimization procedure. In other words, as to each network M_{X} (X∈N) in the recursive transition network, if states are convertible equivalently, they are integrated into one state. However, state integration is not allowed when the number of elements of F_{X} is two or more. This is to simplify the replacement operation of M_{X}.

Simplification of M_{X} is realized by integrating states according to steps shown in Table 1. First, step 1 is repeated until there is no change in M_{X}, so that states are integrated. Then, step 2 is repeated until there is no change in M_{X}. Symbols used in the following are q, q′, q″∈Q_{X}, A∈Σ_{I}.

TABLE 1
SIMPLIFICATION OF NETWORK Mx

| | |
|---|---|
| Step 1 | Integrate q′ and q″ if there is an existence of |
| | q, (q, A, q′) ∈Eₓ, (q, A, q″) ∈Eₓ, and q′, q″ ∉Fₓ. |
| Step 2 | Integrate q′ and q″ if there is an existence of |
| | q that satisfies ((q′, A, q) ∈Ex and (q″, A, q) ∈Eₓ) |
| | or ((q′, A, q) ∉Fₓ and (q″, A, q) ∉Fₓ), wherein q′ |
| | and q″ are states and A∈Σ_{I}. |

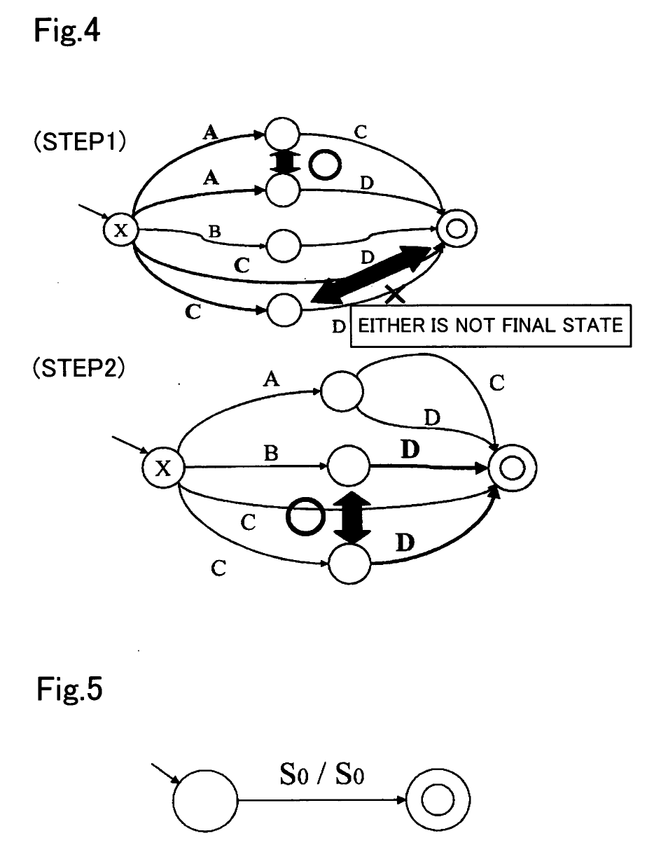

FIG. 4 shows an example of the above described integration process. In step 1, states that are reached from the same state with a transition labeled with A are integrated. In step 2, two states that share the same transition destination state with a transition labeled with D and do not have any destinations labeled with other symbols are integrated. In the simplified recursive transition network, a state where a transition is made from a certain state with the same label includes one final state and one state different from the final state at most.

(Process of Generating a Finite State Transducer Using the Recursive Transition Network in the arc Replacement Part 3)

A Process of Generating a Finite State Transducer Using the Recursive Transition Network Created in the Above-described Process Will be Described. First, an Initial Finite State Transducer M_{O} may be Defined by:

$${M}_{0} = ( {Q}_{0} , {Σ}_{I} , {Σ}_{O} , i , F , {E}_{0} )$$

wherein Q₀={ i, f}, Σ_{I}=N∪T, Σ₀⊂ (([_{N}]*(Σ_{I})*(_{N}])*), F={f}, E₀={ (i, S₀, S₀, f) }.

FIG. 5 shows the initial finite state transducer M₀. An arc in the initial finite state transducer M_{O} is replaced by network M_{S0}, such that a new arc is created. The newly created arc is replaced by another network. This replacement operation is recursively repeated, so that a finite state transducer is obtained. The replacement operation is carried out for an arc whose input label is a non-terminal symbol. An arc having input label X is replaced by M_{X}.

A change in the finite state transducer before and after the replacement operation will be described. The finite state transducer obtained by repeating the replacement operation several times as to the finite state transducer M₀ is referred to as Mⱼ. Mⱼ is defined by (Qⱼ, Σ_{I}, Σ₀, i, F, Eⱼ). An arc, which is defined by e= (qs, X, ₀₁X₀ᵣ, qₑ)∈Eⱼ wherein _{01, 0r} are a category series with a left bracket “([_{N}])*” and a category series with a right bracket “(_{N}))*” in their output alphabets respectively, is replaced by M_{X}, thereby obtaining the finite state transducer Mⱼ. Mⱼ is generated by adding new states and arcs to Qⱼ and Eⱼ. Therefore, as a set of states and a set of arcs change, Mⱼ is defined as (Q′ⱼ, Σ₁, Σ₀, i, F, E′ⱼ). Q′ⱼ and E′ⱼ can be defined by:

$$\begin{matrix}{Q}_{j}^{′} = {Q}_{j} ⋃ \\ \{ eq \vert q ∈ ( {Q}_{X} - \{ {i}_{X} , {f}_{X} \} ) \} \\ {E}_{j}^{′} = ( {E}_{j} - \{ e \} ) ⋃ \\ \{ ( {eq}_{1} , A , A , {eq}_{2} ) \vert ( {q}_{i} , A , {q}_{2} ) ∈ {E}_{X} \} ⋃ \\ \{ ( {q}_{s} , A , {o}_{l} {[}_{X} A , {eq}_{2} ) \vert ( {i}_{X} , A , {q}_{2} ) ∈ {E}_{X} \} ⋃ \\ \{ ( {eq}_{1} , A , {A}_{X} ] {o}_{r} , {q}_{e} ) \vert ( {q}_{1} , A , {f}_{X} ) ∈ {E}_{X} \} ⋃ \\ \{ ( {q}_{s} , A , {o}_{l} {[}_{X} {A}_{X} ] {o}_{r} , {q}_{e} ) \vert ( {i}_{X} , A , {f}_{X} ) ∈ {E}_{X}\end{matrix}$$

wherein q₁≠i_{X}, and q₂≠f_{X}.

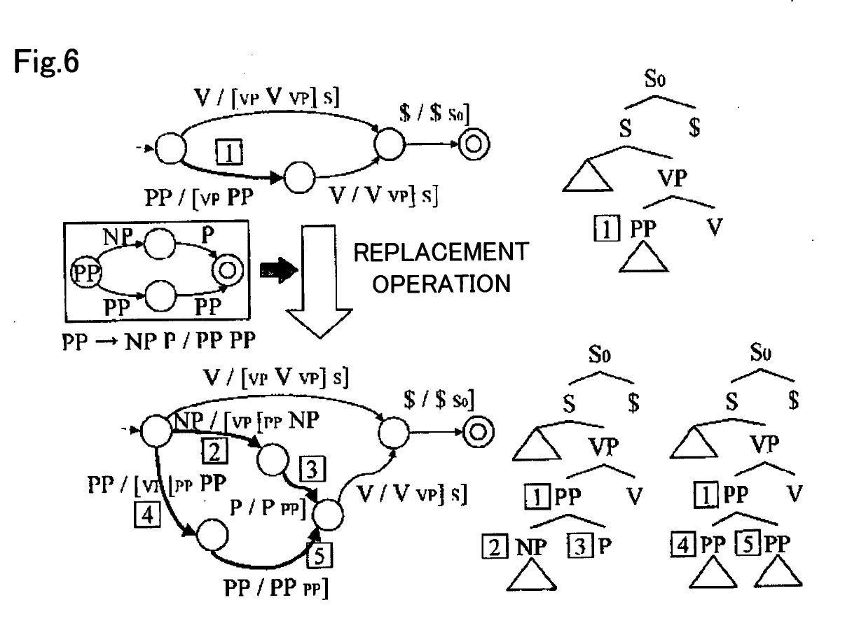

FIG. 6 shows an example of the replacement operation. In FIG. 6, S₀ represents a start symbol, S represents a sentence, P represents a postposition, PP represents a postpositional phrase, NP represents a noun phrase, V represents a verb, VP represents a verb phrase, and $ represents a full stop. The left side of FIG. 6 shows a replacement operation where an arc whose input label is PP is replaced by a network Mpp representing a certain set of grammar rules having PP in the left side hand, and the right side of FIG. 6 shows corresponding parse trees.

On the whole, the replacement operation can be continued endlessly. However, memory in a computer implementing the finite state transducer generator is limited, and the size of the finite state transducer which can be generated is also limited. In the embodiment, a threshold value is set regarding the number of arcs representing the size of the finite state transducer. When the number of arcs reaches a threshold value λ (in other words, when the finite state transducer reaches a specified size by repeating the arc replacement operation), the arc replacement operation is terminated, thereby realizing the finite state transducer with approximately.

(Process of Determining an arc Replacement Order Utilizing Statistical Information in the Priority Calculating Part 4)

Through the arc replacement operation performed in the arc replacement part 3, the finite state transducer for use in incremental parsing can be generated. However, simply repeating the replacement operation alone may cause a problem that may terminate the replacement operation before a necessary arc is replaced. Therefore, when the replacement operation is performed, selection of arcs to be replaced is crucial. Using the statistical information as to frequency of applying grammar rules stored in the statistical information memory storage 11, the priority calculating part 4 determines an arc replacement order from relationship between arcs in the finite state transducer and nodes of a parse tree, based on that an arc corresponding to a node with higher derivation probability needs to be replaced.

The relationship between arcs in the finite state transducer and nodes of a parse tree will be described. The arcs in the finite state transducer are generated by recursively performing a network-based replacement operation starting from an arc whose input label is S₀. As a network represents a set of grammar rules, it can be considered that the grammar rules are applied to the arcs. On the other hand, when a parse tree is generated with a top-down procedure in the context-free grammar, the nodes are generated by applying the grammar rules first to S₀ to generate a node and recursively applying the grammar rules to the generated node. That is, both arcs and nodes are generated by recursively applying the grammar rules starting from the start symbol. The grammar rule application operation to the arc can be associated with that to the nodes. Thus, the arcs and nodes generated through the operation can be associated with each other. FIG. 6 shows an example of an arc-to-node correspondence using numbers. For example, an arc and a node indicated by number 1 in the figure are generated by applying the grammar rules in the following order: S₀→S$, S→ . . . VP, VP→PP V. Thus, the arcs and nodes are associated with each other.

To generate a parse tree including a certain node in the parsing utilizing the finite state transducer, an arc corresponding to the certain node should be replaced. As the number of arcs to be generated is limited, however, not all of arcs are finally replaced. That is, not every parse tree can be generated. To generate a finite state transducer that can generate parse trees as much as possible, the arc replacement order should be considered. An index to determine the arc replacement order is referred to as a replacement priority. A parse tree including a node with a high derivation probability is more frequently generated. Therefore, it is considered that an arc corresponding to such a node should be replaced in preference to other arcs. A replacement priority value is set to a derivation probability of a corresponding node. When the finite state transducer is generated, the replacement priority is calculated for each of all arcs whose input labels are non-terminal symbols, using the statistical information regarding the frequency of applying the grammar rules stored in the statistical information memory storage 11, and the arc replacement operation is applied to the arcs in descending order of the arc replacement priority value in the arc replacement part 3.

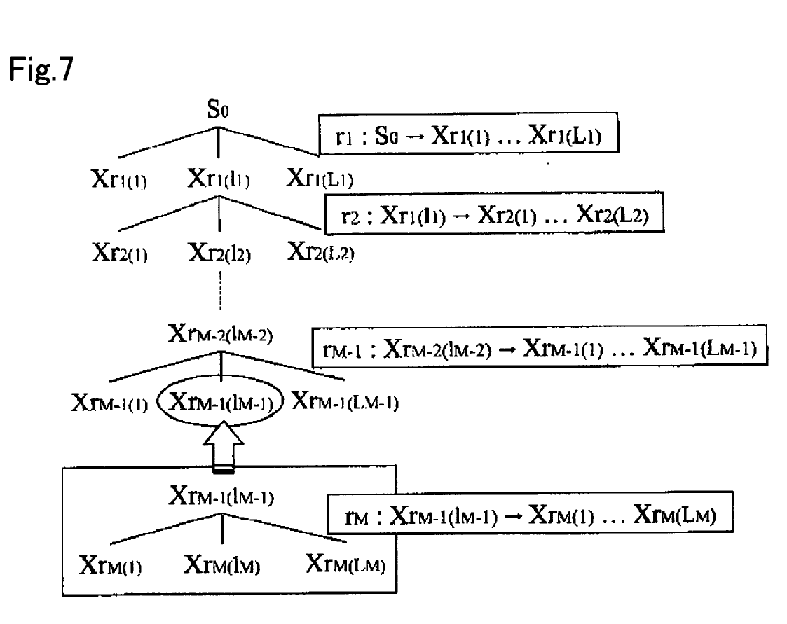

Next, the calculation to obtain the derivation probability of a node will be described. Nodes of a parse tree are generated by applying the grammar rules to each node on a path from the root node S₀ to the node in order. The derivation probability is defined as a probability that the grammar rules are applied to each node in order on a path from S₀ to a node whose derivation probability is desired. In FIG. 7, node X_{rM(lM)} is generated as follows: grammar rule r_{1 is applied to the root node S}₀ of the parse tree to generate nodes, grammar rule r₂ is applied to node Xr₁₍₁₁₎ that is the l₁-th node from the left of the nodes generated by the grammar rule r₁, and finally grammar rule r_{M} is applied to a node that is the l_{M-1}-th node from the left of the nodes generated by grammar rule rₘ₋₁. The derivation probability P (Xr_{M(lM)}) for the node Xr_{M(lM) is determined by:}

$$\begin{matrix}P ( {X}_{{r}_{M ( {l}_{M} )}} ) = P ( {r}_{1 ( {l}_{1} )} , {r}_{2 ( {l}_{2} )} , … , {r}_{M - 1 ( {l}_{M - 1} )} , {r}_{M ( {l}_{M} )} ) \\ = P ( {r}_{1 ( {l}_{1} )} ) \\ \times P ( {r}_{2 ( {l}_{2} )} \vert {r}_{1 ( {l}_{1} )} ) \\ \times P ( {r}_{3 ( {l}_{3} )} \vert {r}_{1 ( {l}_{1} )} , {r}_{2 ( {l}_{2} )} ) \\ ⋮ \\ \times P ( {r}_{M ( {l}_{M} )} \vert {r}_{1 ( {l}_{1} )} , … , {r}_{M - 1 ( {l}_{M - 1} )} )\end{matrix}$$

wherein rᵢ(lᵢ) represents that grammar rule rᵢ is applied and grammar rule rᵢ+1 to be applied next is applied to a node generated by the (lᵢ)-th element of the right side of rᵢ. The reason why the position where the grammar rule is applied needs to be considered is because the grammar rules to be applied are different according to positions even in the same category. For example, when grammar rule N→NN is used, applicable grammar rules are different between the first N and the second N of the right hand side.

In the above expression, the value for P(rᵢ₍ₗᵢ₎|r₁₍₁₁₎, . . . , rᵢ₋₁₍₁ᵢ₋₁₎) is not affected by the applied position of the following grammar rule. Thus, the above expression can be rewritten by:

$$\begin{matrix}P ( {X}_{{r}_{M ( {l}_{M} )}} ) = P ( {r}_{1 ( {l}_{1} )} , {r}_{2 ( {l}_{2} )} , … , {r}_{M - 1 ( {l}_{M - 1} )} , {r}_{M} ) \\ = P ( {r}_{1} ) \\ \times P ( {r}_{2} \vert {r}_{1 ( {l}_{1} )} ) \\ \times P ( {r}_{3} \vert {r}_{1 ( {l}_{1} )} , {r}_{2 ( {l}_{2} )} ) \\ ⋮ \\ \times P ( {r}_{M} \vert {r}_{1 ( {l}_{1} )} , … , {r}_{M - 1 ( {l}_{M - 1} )} )\end{matrix}$$

The probability to derive a node is found in this way. However, if a grammar rule application probability is found from all grammar rules applied to find the derivation probability of a node as in expression 8, a data sparseness problem may arise, so that a finite state transducer to be generated is apt to depend on learning data. In the priority calculating part 4, the probability which the grammar rules are applied to a certain node depends on the grammar rules which have been applied to N−1 nodes tracing back in order from the certain node and the positions where the grammar rules have been applied. The obtained application probability is smoothed using a low-level conditional probability and liner interpolation.

A method for calculating the approximate probability P of applying the grammar rules will be described. The approximate probability P is determined by:

$$P ( {r}_{i} \vert {r}_{1 - N + 1 ( {l}_{i - N + 1} )} , … , {r}_{i - 1 ( {l}_{i - 1} )} )$$

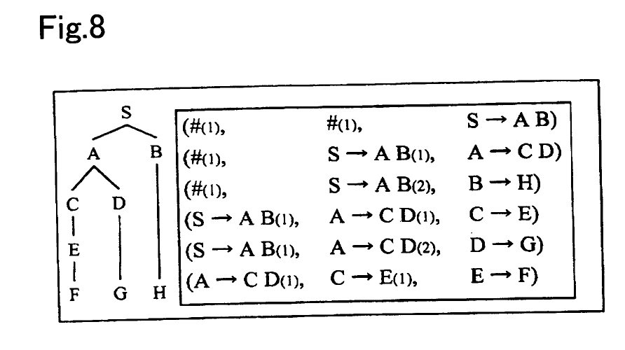

When grammar rules are applied to a certain node, nodes on a path from the root node S₀ to the certain node are traced in order, so that a N−1-tuple that pairs an applied grammar rule with a position on the right side of the applied grammar rule where a subsequent grammar rule is applied, is obtained. The currently applied grammar rule is matched with the N−1-tuple, and the certain node can be represented by a N-tuple (r₁₍ₗᵢ₎, . . . , r_{N-1(lN-1)}, r_{N}). In FIG. 8, for example, a parse tree is generated by applying six grammar rules. Six groups are obtained from the parse tree. When N=3, six 3-tuples are obtained as shown in FIG. 8. It is assumed that a null rule (#) is applied to nodes located above the start symbol of the parse tree.

Using a set of N-tuples obtained from learning data, the probability that grammar rule r_{N} with a condition of (r₁₍ₗᵢ₎, . . . , r_{N-1(lN-1)}) is applied is determined by:

$$P ( {r}_{N} \vert {r}_{1 ( {l}_{1} )} , … {r}_{N - 1 ( {l}_{N - 1} )} ) = \frac{C ( {r}_{1 ( {l}_{1} )} , … {r}_{N - 1 ( {l}_{N - 1} )} , {r}_{N} )}{{Σ}_{{r}_{N}} C ( {r}_{1 ( {l}_{1} )} , … {r}_{N - 1 ( {l}_{N - 1} )} , {r}_{N} )}$$

wherein C(X) is the number of occurrences of X.

To obtain the probability of applying the grammar rules, linear interpolation values may be used. The linear interpolation values may be obtained by:

$$\begin{matrix}{\hat{P}}_{N} ( {r}_{N} \vert {r}_{1 ( {l}_{1} )} , … , {r}_{N - 1 ( {l}_{N - 1} )} ) = {λ}_{N} {P}_{N} ( {r}_{N} \vert {r}_{1 ( {l}_{1} )} , … , {r}_{N - 1 ( {l}_{N - 1} )} ) + \\ {λ}_{N - 1} {P}_{N - 1} ( {r}_{N} \vert {r}_{2 ( {l}_{2} )} , … , {r}_{N - 1 ( {l}_{N - 1} )} ) \\ ⋮ \\ + {λ}_{2} {P}_{2} ( {r}_{N} \vert {r}_{N - 1 ( {l}_{N - 1} )} ) + \\ {λ}_{1} {P}_{1} ( {r}_{N} \vert LHS ( {r}_{N} ) )\end{matrix}$$

wherein λ₁, . . . , λ_{N} are interpolation coefficients, and LHS(r_{N}) represents the left side category of r_{N}. Any condition except for P1(r_{N}|LHS(r_{N})) does not include LHS(r_{N}). This is because it is clear that the category in the position 1_{N-1} of the grammar rule r_{N-1} is LHS(r_{N}).

Finally, in this procedure, the derivation probability for a certain node is determined by:

$$P ( {X}_{{r}_{M ( {l}_{M} )}} ) = {\prod }_{i = 1}^{M} \hat{P} ( {r}_{i} \vert {r}_{i - N + 1 ( {l}_{i - N + 1} )} , … , {r}_{i - 1 ( {l}_{i - 1} )} )$$

In consequence of the integration of the states in the recursive transition network, the arcs generated from plural grammar rules exist in the recursive transition network. Therefore, one arc corresponds to two or more nodes of the parse tree in some case. In this case, the sum of the derivation probabilities of all the corresponding nodes is used as the derivation probability.

(Process of Eliminating arcs Labeled with Non-terminal Symbols in the arc Eliminating Part 4)

In the above process of generating the finite state transducer performed in the arc replacement part 3, when the number of arcs reaches threshold λ, the replacement operation is immediately terminated, and non-terminal symbols that were not replaced by the network remain unchanged in the finite state transducer. With the parsing of the embodiment, however, a state transition is made only when a part of speech of an input label of an arc matches a part of speech of a word inputted in the system, and any arcs whose input label is a non-terminal symbol are not used during parsing. Therefore, leaving these arcs is wasteful, and eliminating such arcs does not cause any problems. In fact, further performing the arc replacement while eliminating such arcs will improve the parsing capability of the finite state transducer. The following describes a process for eliminating arcs labeled with non-terminal symbols and further continuing performing the arc replacement operation.

First, the finite state transducer is generated by the process of the arc replacement part 3. When the number of arcs reaches threshold λ, the replacement operation is immediately terminated, and the following procedure is executed.

(Procedure to Eliminate arcs whose Input Label is a Non-terminal Symbol)

Step A1: Arc e which has the highest replacement priority is selected from arcs labeled with non-terminal symbols as an arc to be replaced next. Input label of the arc e is I(e).

Step A2: It is checked whether replacement of arc e is valid. If it is not valid, arc e is eliminated and the procedure returns to step A1.

Step A3: Arcs in the finite state transducer, whose input labels are non-terminal symbols, are eliminated in order of ascending replacement priorities. The number of arcs to be eliminated is represented by λ-((the number of arcs in the finite state transducer)—(the number of arcs included in M_{I(e)}) −1). When the obtained number is negative, the arc is not eliminated.

Step A4: Arc e is replaced by network M_{I(e)}.

Step A5: If any arc whose input label is a non-terminal symbol remains in the finite state transducer, the procedure repeats steps A1 to A4.

In step A2 for validity check, arc e is checked as to whether there is an arc where the state at the start point of arc e is a transition destination, whether there is an arc where the state at the end point of the arc e is a transition source, whether the state is the initial state, or whether the state is the final state. If neither one is applicable, arc e is not analyzed, so that it is eliminated.

Through this operation, among the remaining arcs, arcs having higher replacement priority are further replaced, and arcs with lower replacement priority are eliminated. However, after the arcs are eliminated, any arcs cannot be reached from the initial state or cannot reach the final state will appear. These arcs cannot be used for parsing either. Therefore, when an arc is eliminated, the implications of the arc elimination are investigated. If an unusable arc further appears, the arc is eliminated together with arcs with lower replacement priority. When an arc is eliminated, the following is performed.

(A Method to Eliminate Unnecessary arcs)

When an arc is eliminated, the following are checked as to every arc that shares the states of the start point and end point of the arc. If any one of the following conditions is applicable, the arc is eliminated according to the corresponding instruction. As to the eliminated arc, the same operations are recursively performed.

Step B1: When there is no arc that shares the start point of the eliminated arc as a transition destination, every arc that shares the start point of the eliminated arc as its start point is eliminated.

Step B2: When there is no other arc that shares the start point of the eliminated arc as a transition source, every arc that shares the start point of the eliminated arc as its end point is eliminated.

Step B3: When there is no other arc that shares the end point of the eliminated arc as a transition destination, every arc that shares the end point of the eliminated arc as its start point is eliminated.

Step B4: When there is no arc that shares the end point of the eliminated arc as a transition source, every arc that shares the end point of the eliminated arc as its end point is eliminated.

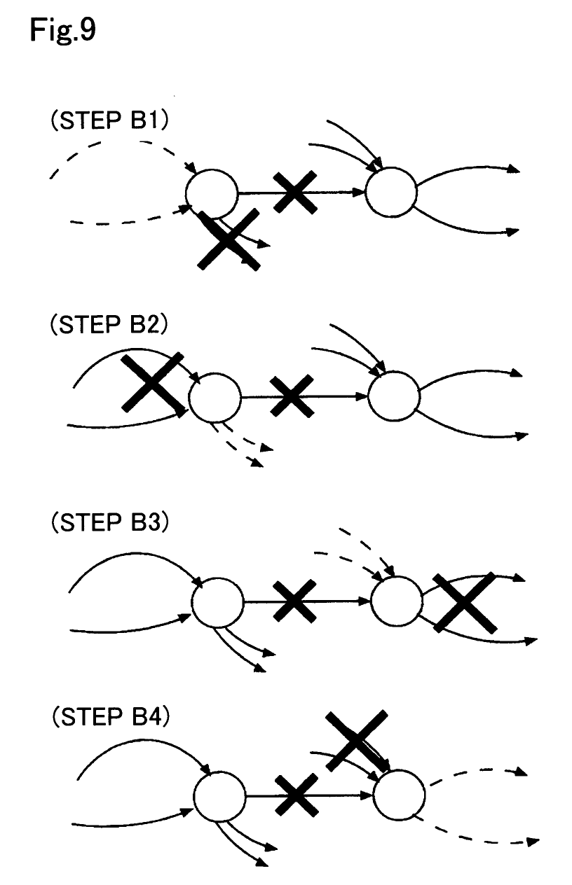

The above steps B1 to B4 are illustrated in FIG. 9. In FIG. 9, arcs indicated by a dotted line represent nonexistent arcs in each pattern. In each figure, as the arcs indicated by a dotted line are not existent when a central arc indicated by an “X” mark is eliminated, arcs further eliminated are also indicated by an “X” mark.

As a result of performing each process in the recursive transition network generating part 2, the arc replacement part 3, the priority calculating part 4, and the arc eliminating part 5, which are included in the finite state transducer generator 1, a finite transducer for use in incremental parsing is obtained.

(Incremental Generation of Parse Tree By an Incremental Parsing Apparatus 21)

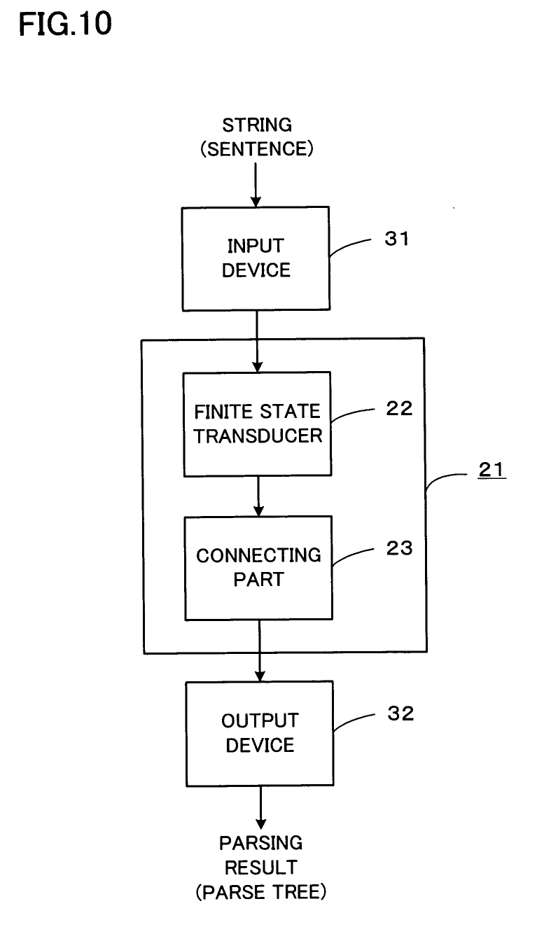

An incremental parsing apparatus 21 utilizing the finite state transducer 22 generated by the finite state transducer generator 1 will be described with reference to FIG. 10.

The incremental parsing apparatus 21 is made up of an input device 31, the finite state transducer 22, a connecting part 23, and an output device 32. The incremental parsing apparatus 21 is realized by a computer, which specifically includes CPU, ROM, RAM, a hard disk, a voice input device, and a display.

The input device 31 is designed to input a sentence to be parsed, and made up of a conventional sentence input device such as a voice input device or a keyboard. When sentences are inputted into the input device externally, the input device 31 inputs the sentences (word strings) into the finite state transducer 22 sequentially.

The finite state transducer 22 is a finite state transducer reflecting a result that a process of applying the grammar rules is previously calculated, and is generated by the above finite state transducer generator 1. The finite state transducer 22 makes a state transition for each word string inputted via the input device 31 and simultaneously outputs each piece of parse trees generated through the grammar rule application in order. The finite state transducer 22 is realized by that the CPU reads and executes the finite state transducer program stored in ROM or the hard disk.

The connecting part 23 sequentially connects each piece of the parse tree outputted by the finite state transducer 22. Thus, even in the middle of a sentence, the connecting part 23 can generate a parse tree for what has been inputted so far. The connecting part 23 is realized by that the CPU reads and executes a concatenation program stored in ROM or the hard disk.

The output device 32 outputs a parse tree generated by the finite state transducer 22 and the connecting part 23, as a result of parsing an inputted sentence. The output device 32 outputs a parsing result in the form of a file in RAM or the hard disk, or an indication on a display.

A process of generating parse trees incrementally in the incremental parsing apparatus 21 will be described. In the incremental parsing apparatus 21 of the embodiment, fundamentally words are successively inputted from the input device 31 to the finite state transducer 22, state transitions are made, and the parse trees are obtained. However, as the finite state transducer 22 generated by the finite state transducer generator 1 is non-deterministic, there is some possibility that two or more transition destinations exist as to an input. It is considered that in incremental parsing, a parsing structure should be outputted in accordance with each input. In the embodiment, a breadth first search is performed to generate a parse tree. The incremental parsing apparatus 12 has a list showing that the states and symbol strings each representing a parse tree outputted so far are linked in one on one relationship. When each word is inputted, all possible state transitions are made from the current state. At this time, the connecting part 23 connects a symbol string representing a parse tree for word string(s) inputted so far and an output label indicated with an arc in which a state transition is made, and a new parse tree is generated.

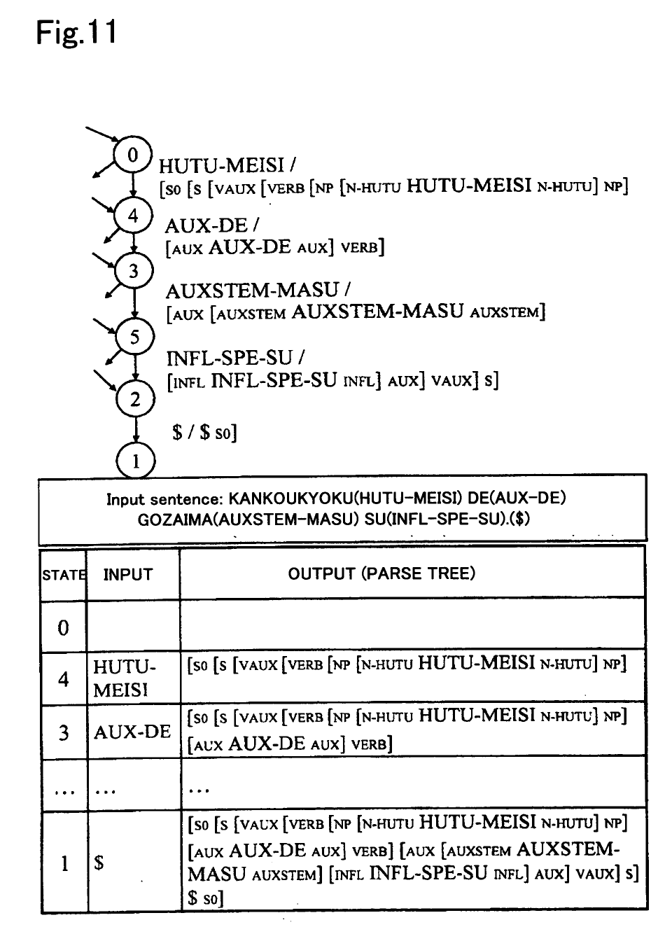

An example of actions in the incremental parsing apparatus 21 for Japanese will be described with reference to FIG. 11. A meaning in Japanese for each output symbol shown in FIG. 11 is put in parentheses as follows: S₀ (start symbol), S (sentence), NP (noun phrase), N-HUTU (common noun), HUTU-MEISI (common noun phrase), VAUX (verb phrase), VERB (verb), AUX (postpositional particle), AUX-DE (postpositional particle of Japanese, “de”), AUXSTEM (particle stem), AUXSTEM-MASU (particle stem of Japanese, “(gozai) masu”), INFL (conjugation ending), INFL-SPE-SU (conjugation ending of Japanese, “su”), and $(period).

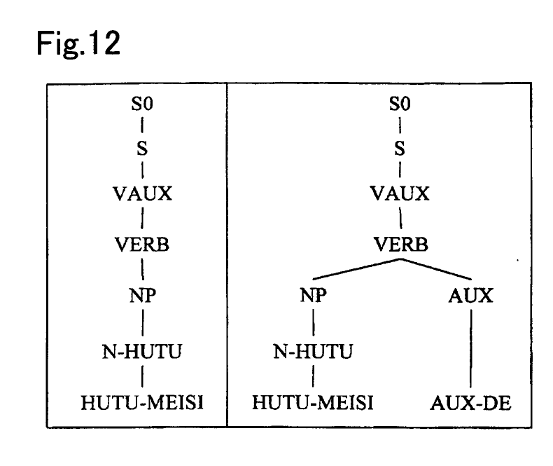

Every time a word is inputted from the input device 31 to the finite state transducer 22, the finite state transducer 22 makes a state transition, and the output label of the arc where the state transition is made is connected by the connecting part 23. An output symbol string (which is a set of output labels connected) represents a parse tree. When a part of speech, for example, “HUTU-MEISI” (common noun) is inputted, its corresponding symbol string to be outputted represents a parse tree shown on the left side of FIG. 12. A parse tree shown on the right side of FIG. 12 represents a symbol string when input up to “AUX-DE” (postpositional particle of Japanese “de”) has been done. In this way, the parse tree is expanded for every word input. In this example, a transition does not include ambiguity, and only one parse tree is outputted for each input of a particle of speech. However, as described above, when two or more transitions are possible, states and symbol strings are kept in pair, and parse trees corresponding to the number of transitions are made.

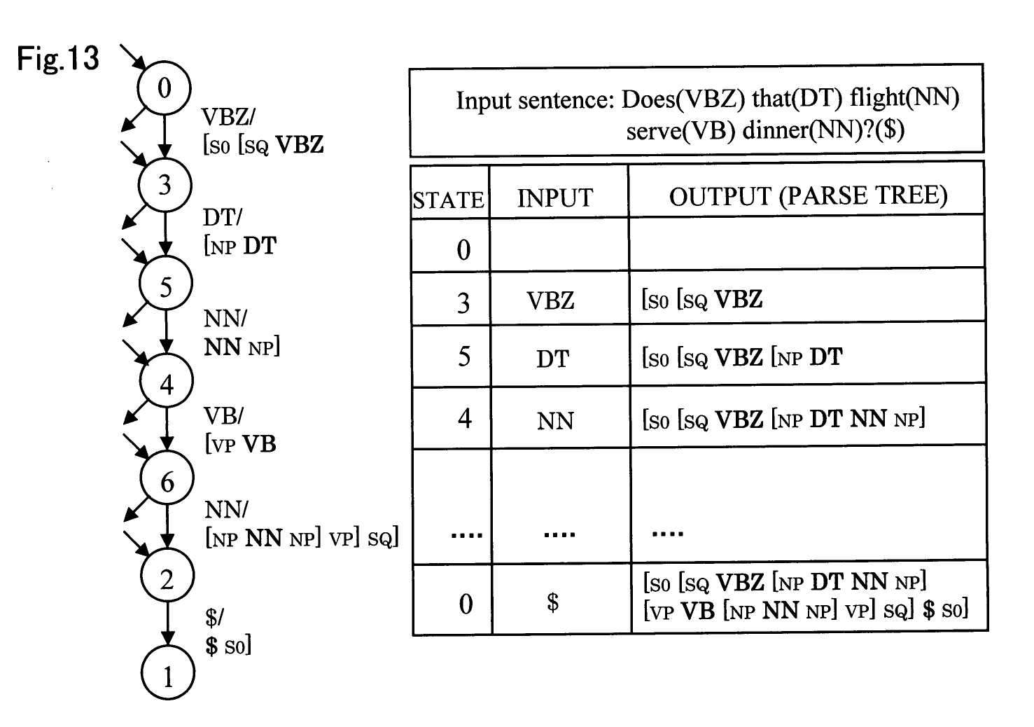

Next, an example of actions in another embodiment of the incremental parsing apparatus 21, which includes a finite state transducer generated with using the statistical information regarding frequency of applying English grammar rules, will be described with reference to FIG. 13. A meaning for each output symbol shown in FIG. 13 is put in parentheses as follows: S₀ (sentence), SQ(inversed yes/no question), VBZ (verb, 3^{rd} person singular present), NP(noun phrase), DT(determiner), NN(noun, singular or mass), VP(verb phrase), VB(verb, base form), and $(period).

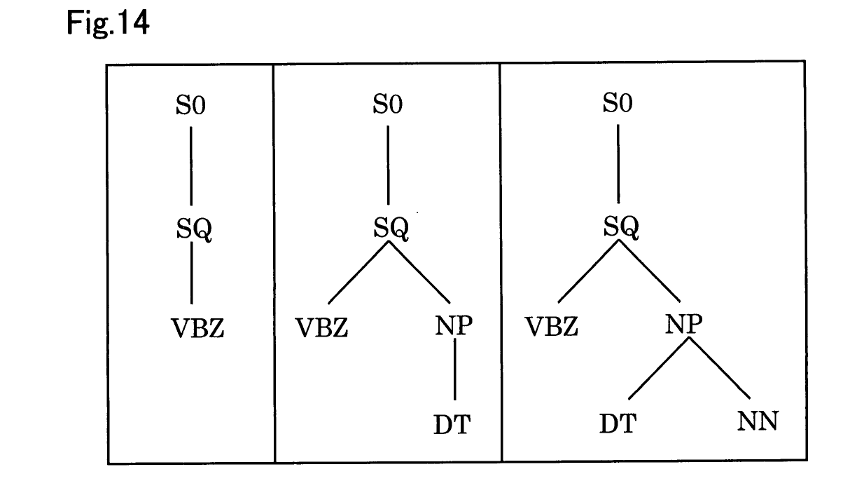

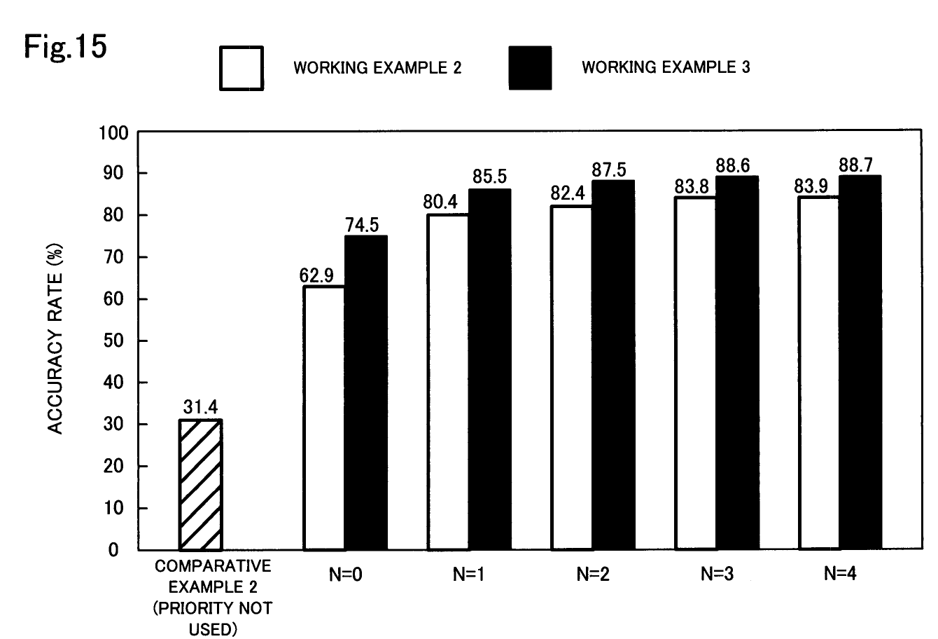

Every time a word is inputted from the input device 31 to the finite state transducer 22, the finite state transducer 22 makes a state transition, and the output label of the arc where the state transition is made is connected by the connecting part 23. An output symbol string (which is a set of output labels connected) represents a parse tree. When a part of speech, for example, “VBZ” is inputted, its corresponding symbol string to be outputted represents,a parse tree shown on the left side of FIG. 14. A parse tree shown on the center of FIG. 14 represents a symbol string when input up to “DT” has been done. Further, a parse tree shown on the right side of FIG. 14 represents a symbol string when input up to “NN” has been done.

According to the finite state transducer generator 1, the arc replacement priority is calculated based on the statistical information regarding the frequency of applying the grammar rules, and the arc replacement operation is applied to arcs in descending order of the arc replacement priority, thus reliably generating a finite state transducer which can parse a great number of sentences within the limited size.

According to the embodiment, the finite state transducer generator 1 further includes the arc eliminating part 5. When the finite state transducer reaches a specified size, the arc replacement part 3 terminates the arc replacement operation. Then, the arc eliminating part 5 eliminates arcs whose input labels are non-terminal symbols, which are not used for parsing, and simultaneously performs the arc replacement operation. This procedure also contributes to a generation of a finite state transducer which can parse a further great number of sentences.

According to the embodiment, the arc replacement operation is performed using a probability that grammar rules are applied to each node on a path from the start symbol to a certain node, as the arc replacement priority. Thus, the finite state transducer generator 1 can reliably a generator that can parse a considerable number of sentences.

In the incremental parsing apparatus 21, in other words, the finite state transducer 22 is generated by applying the arc replacement operation to the arcs starting from an arc having a highest priority obtained based on the statistical information regarding the frequency of applying the grammar rules. Using the finite state transducer of a limited size approximately transformed from the context-free grammar, the incremental parsing apparatus can parse a great number of sentences.

(Experiment)

Through the use of the finite state transducer generator 1 of the embodiment as describe above, a finite state transducer was generated, and the incremental parsing apparatus 21 was created by using the finite state transducer. To investigate the effect on incremental parsing in the incremental parsing apparatus 21, we conducted some experiments on parsing. We used a computer with the following specification for the experiments: Pentium® 4, 2 GHz of CPU and 2 GB of memory. We used ATR speech database with parse trees (Japanese dialogue) as a learning data set and a test data set for the experiment. Using 9,081 sentences extracted at random from the speech database as the learning data set (statistical information as to frequency of applying grammar rules), we obtained the grammar rules and the application probability. At that time, there were 698 grammar rules, 337 particles of speech, and 153 categories. We used 1,874 sentences as the test data set. The average sentence length of the test data set was 9.4 words. We set the threshold value for the number of arcs of the finite state transducer to 15,000,000. This is because memory was used nearly to its maximum at the time of generation of the finite state transducer. The memory used during parsing was about 600 MB.

(Experimental Results)

We conducted parsing on two parsing apparatuses to discuss comparisons of parsing time and parsing accuracy. One device was the incremental parsing apparatus 21 using the finite state transducer 22 of the embodiment (hereinafter referred to as a working example 1) and the other one was a parsing apparatus using a conventional incremental chart parsing (hereinafter referred to as a comparative example 1). The finite state transducer 22 of the working example 1 calculated a replacement priority and determined a replacement order using the grammar rule application probability when N=3. N represents that a group of grammar rules used to find the probability is an N-tuple. The finite state transducer 22 of the working example 1 further eliminated arcs labeled with non-terminal symbols. As to the incremental chart parsing of the comparative example 1, a conditional probability was calculated and utilized for bottom-up parsing, based on the same principle as the grammar rule application probability used for generation of the finite state transducer. The product of the grammar rule application probabilities was calculated for each application of grammar rules. When the value exceeded 1E-12, applying of grammar rules was cancelled. Further applying of grammar rules was controlled with a possibility to reach an undecided term to be replaced. We set the parsing time for a word to 10 seconds on both the parsing apparatuses of the working example 1 and the comparative example 1. When the parsing time was over 10 seconds, parsing of the current word was terminated and parsing of the next word was processed. Table 2 shows parsing time and accuracy rate per word on both the parsing apparatuses of the working example 1 and the comparative example 1. The accuracy rate is a percentage of sentence including correct parse trees obtained as the parsing result from all sentences. A correct parse tree was a parse tree previously given to the sentence.

TABLE 2
Experimental results of comparison between the
working example 1 and the comparative example 1

| | Parsing time | Accuracy |
|---|---|---|
| | (sec./word) | rate (%) |
| Working example 1 | 0.05 | 87.5 |
| Comparative example 1 | 2.82 | 33.4 |
| (incremental chart | | |
| parsing) | | |

It is clear from the experimental results that the incremental parsing apparatus 21 of the working example 1 can process parsing faster than the comparative example 1. Where the average Japanese speech speed is about 0.25 seconds per word, the parsing speed of the working example 1 was 0.05 seconds per word, faster than the speech speed. This shows that the incremental parsing apparatus 21 of the working example 1 is effective in the real-time incremental parsing.

To make a comparison of the number of calculations for one word, we investigated parsing methods of the devices. In parsing according to the working table 1 using the finite state transducer, a calculation was counted each time a state transition was made to generate a parse tree. In the incremental chart parsing of the comparative example 1, a calculation was counted each time the grammar rules were applied, and a calculation was counted each time the tuple was replaced. As a result, the number of calculations for a word was 1,209 for the working example 1, and 36,300 for the comparative example 1, and thus, the number of calculations for the working example 1 was significantly lower than that for the comparative example 1. This experiment resulted in that it is possible to speed up the parsing process using the finite state transducer.

Next, we focused on an incremental parsing apparat us using a finite state transducer, and conducted experiments to investigate accuracy rates as a result of the parsing process. We prepared three examples of incremental parsing apparatuses. Working examples 2, 3 were incremental parsing apparatuses each including a finite state transducer generated with the replacement priority. A comparative example 2 was an incremental parsing apparatus including a finite state transducer generated without the replacement priority. The finite state transducer of the working example 2 was generated without elimination of arcs whose labels were non-terminal symbols. The finite state transducer of the working example 3 was generated with elimination of arcs whose labels were non-terminal symbols. As to the working examples 2, 3, each finite state transducer was generated by changing the number of conditions for the grammar rule application probability in the range from N=0 to N=4. N represents the number of conditions for the grammar rule application probability. The experiment results are shown in FIG. 13.

From the experiment results, we found that the accuracy rates of the working examples 2, 3 whose finite state transducers were generated with the replacement priority were greatly improved compared to the comparative example 2 whose finite state transducer was generated without the replacement priority, in other words, the control of the arc replacement order using the replacement priority was effective. The accuracy rate of the working example 3, whose finite state transducer was generated by eliminating the arcs labeled with non-terminal symbols, was improved, compared to the working example 2, whose finite state transducer was generated without arc removal. Therefore, the working examples 2, 3 showed improvements inaccuracy as compared with the comparative example 2 and accuracy rate of nearly 90% was achieved with the combination of the replacement priority and removal of arcs labeled with non-terminal symbols. In addition, it is evident that the accuracy rate was improved as the number of conditions for the grammar rule application probability N was increased from 0 to 4.

While the invention has been described with reference to a specific embodiment, the description of the embodiment is illustrative only and is not to be construed as limiting the scope of the invention. Various other modifications and changes may occur to those skilled in the art without departing from the spirit and scope of the invention.

In the embodiment, the incremental parsing apparatus 21 is used alone, however, it may be installed in a simultaneous interpretation system or a voice recognition system, thereby realizing the simultaneous interpretation system or voice recognition system so as to work more simultaneously and precisely. When a voice recognition system including the incremental parsing apparatus 21 is installed in a robot, a rapid-response voice input robot or interactive robot can be realized. The incremental parsing apparatus 21 can be installed in automated teller machines (ATMs) placed in financial institutes, car navigation systems, ticket selling machines and other machines.

With the use of a context-free grammar written in a desired language (such as Japanese, English, and German) in the recursive transition network generating part 2, the finite state transducer 22 can be generated in accordance with the desired language. With the use of such a finite state transducer 22, the incremental parsing apparatus 21 can be structured in accordance with the desired language.

What is claimed is:

1. An apparatus for generating a finite state transducer for use in incremental parsing, comprising:
a recursive transition network creating device that creates are cursive transition network, there cursive transition network being a set of networks, each network representing a set of grammar rules based on a context-free grammar by states and arcs connecting the states, each arc having an input label and an output label, each network having a recursive structure where each transition labeled with a non-terminal symbol included in each of the networks is defined by another network;
an arc replacement device that replaces an arc having an input label representing a start symbol included in the finite state transducer in an initial state by a network corresponding to the input label of the arc in the recursive transition network and further recursively repeats an arc replacement operation for replacing each arc, which is newly created from a replaced network, by another network in the recursive transition network; and
a priority calculating device that calculates a derivation probability to derive a node of a parse tree corresponding to each of arcs whose input labels are non-terminal symbols in the finite state transducer based on statistical information regarding frequency of applying grammar rules and determines an arc replacement priority in terms of an obtained derivation probability;
wherein the arc replacement device continues applying the arc replacement operation to each arc included in the finite state transducer in descending order of the arc replacement priority until the finite state transducer reaches a predetermined size.

2. The apparatus according to claim 1, further comprising an arc eliminating device that, after the application of the arc replacement operation by the arc replacement device terminates, eliminates arcs whose input labels are non-terminal symbols and further performs the arc replacement operation.

3. The apparatus according to claim 1, wherein the derivation probability for a certain node represents a probability that grammar rules are applied in order to each node on a path from a root node to the certain node in the parse tree.

4. The apparatus according to claim 3, wherein derivation probability P (Xr_{M(lM)}) for node Xr_{M(lM)} is determined as follows:
$$P ( {X}_{{r}_{M ( {l}_{M} )}} ) = {\prod }_{i = 1}^{M} \hat{P} ( {r}_{i} \vert {r}_{i - N + 1 ( {l}_{i - N + 1} )} , … , {r}_{i - 1 ( {l}_{i - 1} )} )$$
wherein rᵢ represents a grammar rule, rᵢ(lᵢ) represents that grammar rule rᵢ is applied and grammar rule rᵢ+1 to be applied next is applied to a node generated by the (lᵢ)-th element of the right side of rᵢ, and N is a predetermined positive integer.

5. A computer-readable recording medium storing a program for generating a finite state transducer for use in incremental parsing, the program comprising:
a recursive transition network creating routine that creates a recursive transition network, there cursive transition network being a set of networks, each network representing a set of grammar rules based on a context-free grammar by states and arcs connecting the states, each arc having an input label and an output label, each network having a recursive structure where each transition labeled with a non-terminal symbol included in each of the networks is defined by another network;
an arc replacement routine that replaces an arc having an input label representing a start symbol included in the finite state transducer in an initial state by a network corresponding to the input label of the arc in the recursive transition network and further recursively repeats an arc replacement operation for replacing each arc, which is newly created from a replaced network, by another network in the recursive transition network; and
a priority calculating routine that calculates a derivation probability to derive a node of a parse tree corresponding to each of arcs whose input labels are non-terminal symbols in the finite state transducer based on statistical information regarding frequency of applying grammar rules and determines an arc replacement priority in terms of an obtained derivation probability;
wherein the arc replacement routine continues applying the arc replacement operation to each arc included in the finite state transducer in descending order of the arc replacement priority until the finite state transducer reaches a predetermined size.

6. The computer-readable recording medium according to claim 5, the program further comprising an arc eliminating routine that, after the application of the arc replacement operation by the arc replacement routine terminates, eliminates arcs whose input labels are non-terminal symbols and further performs the arc replacement operation.

7. The computer-readable recording medium according to claim 5, wherein, in the program, the derivation probability for a certain node represents a probability that grammar rules are applied in order to each node on a path from a root node to the certain node in the parse tree.

8. The computer-readable recording medium according to claim 7, wherein derivation probability P (Xr_{M(lM)}) for node Xr_{M(lm)} is determined as follows:
$$P ( {X}_{{r}_{M ( {l}_{M} )}} ) = {\prod }_{i = 1}^{M} \hat{P} ( {r}_{i} \vert {r}_{i - N + 1 ( {l}_{i - N + 1} )} , … , {r}_{i - 1 ( {l}_{i - 1} )} )$$
wherein rᵢ represents a grammar rule, rᵢ(lᵢ) represents that grammar rule rᵢ is applied and grammar rule rᵢ+1 to be applied next is applied to a node generated by the (lᵢ)-th element of the right side of rᵢ, and N is a predetermined positive integer.

9. A method for generating a finite state transducer for use in incremental parsing comprising the steps of:
creating a recursive transition network, the recursive transition network being a set of networks, each network representing a set of grammar rules based on a context-free grammar by states and arcs connecting the states, each arc having an input label and an output label, each network having a recursive structure where each transition labeled with a non-terminal symbol included in each of the networks is defined by another network;
replacing an arc having an input label representing a start symbol included in the finite state transducer in an initial state by a network corresponding to the input label of the arc in the recursive transition network and further recursively repeating an arc replacement operation for replacing each arc, which is newly created from a replaced network, by another network in the recursive transition network; and
calculating a derivation probability to derive a node of a parse tree corresponding to each of arcs whose input labels are non-terminal symbols in the finite state transducer based on statistical information regarding frequency of applying grammar rules and determines an arc replacement priority in terms of an obtained derivation probability;
wherein, in the step of replacing an arc, continuing applying the arc replacement operation to each arc included in the finite state transducer in descending order of the arc replacement priority until the finite state transducer reaches a predetermined size.

10. The method according to claim 9, further comprising the step of eliminating arcs whose input labels are non-terminal symbols and further performs the arc replacement operation, after the application of the arc replacement operation by the arc replacement device terminates.

11. The method according to claim 9, wherein the derivation probability for a certain node represents a probability that grammar rules are applied in order to each node on a path from a root node to the certain node in the parse tree.

12. The method according to claim 11, wherein derivation probability P (Xr_{M(lM)}) for node Xr_{M(lM)} is determined as follows:
$$P ( {X}_{{r}_{M ( {l}_{M} )}} ) = {\prod }_{i = 1}^{M} \hat{P} ( {r}_{i} \vert {r}_{i - N + 1 ( {l}_{i - N + 1} )} , … , {r}_{i - 1 ( {l}_{i - 1} )} )$$
wherein rᵢ represents a grammar rule, rᵢ(lᵢ) represents that grammar rule rᵢ is applied and grammar rule rᵢ+1 to be applied next is applied to a node generated by the (lᵢ)-th element of the right side of rᵢ, and N is a predetermined positive integer.

13. An apparatus for incremental parsing, comprising:
a finite state transducer generated by the method according to claim 7, the finite state transducer outputting one or more pieces of a parse tree as a result of a state transition when each word is inputted thereto; and
a connecting device that sequentially connects each piece of the parse tree outputted by the finite state transducer.
